(19) United States
(12) Patent Application Publication
(10) Pub. No.: US 2018/0322319 A1
(43) Pub. Date: Nov. 8, 2018

(54) MULTIRESONATOR RADIO FREQUENCY IDENTIFICATION (RFID) TAG OVERLAY AS TAG RECODING

(71) Applicant: Xerox Corporation, Norwalk, CT (US)

(72) Inventors: George A. GIBSON, Fairport, NY (US); Wayne Alan BUCHAR, Bloomfield, NY (US)

(21) Appl. No.: 15/585,369

(22) Filed: May 3, 2017

(51) Int. Cl. G06K 7/10

(52) U.S. Cl. CPC G06K 7/10069

(57) ABSTRACT

An improved system and method is provided for using the superposition of a number of extremely low cost multiresonator tags that can be configured to allow information to be written to the tag after application. The new information is written through layering of tags to encode information on an object to which the tags are affixed.

This invention relates generally to radio-frequency identification (RFID) tags, and more particularly, to ultra wideband pulse-based radio frequency identification (UWB RFID) system.

### BACKGROUND OF THE INVENTION

The use of radio frequency identification (RFID) tags to track, identify and locate goods has grown significantly in recent years. RFID tags allow manufacturers, distributors and retailers, amongst others, to regulate products and inventory, quickly determine production, manufacture, distribution or retail needs and efficiently intake and outtake items utilizing RFID tags. The RFID tags themselves can provide links to any desired product data and may be scanned or read in any of a variety of manners. RFID tags have been proposed as a replacement to barcodes due to their long reading range, ability to read without line of sight, and automated identification and tracking.

As a practical matter, RFID technology uses radio frequencies that have much better penetration characteristics to material than do optical signals, and will work under more hostile environmental conditions than bar code labels. Therefore, the RFID tags may be read through paint, dirt, dust, human bodies, concrete, or through the tagged item itself. RFID tags may be used in managing inventory, automatic identification of cars on toil roads, security systems, electronic access cards, keyless entry and the like.

While the scope of application of RFID systems is expanding, RFID tags tend not to be used in low cost applications like on printed matter and the like because of their cost compared to barcodes. Accordingly, research effort has focused on developing chipless printable RFID (CRFID) tags which can be used like barcodes. Chipless RFID (CRFID) tags do not contain a microchip but instead, rely on magnetic materials or transistorless thin film circuits to store data.

CFRID tags are cheaper, thinner, and more flexible than radio frequency identification tags that have microchip. CRFID tags work over a wider temperature range and are less susceptible to electrical interference than are radio frequency identification tags that have a microchip. Chipless radio frequency identification elements do not need microchips for storing information. Information storage relies on the antennas or resonant elements. The chipless radio frequency identification elements can be compounded as additive(s) into different compositions and/or affixed to articles of manufacture such as printed matter. Containers molded from these compositions can be read by radio frequency identification signals. This feature allows chipless RFID tags to be fabricated at much lower costs than traditional RFID tags.

Resonators (antennae) are an element of RFID tags that are typically prepared via stamping/etching techniques, wherein a foil master is carved away to create the final structure. The RFID resonator may also be printed directly on the substrate using a conductive metal ink. The ink is printed on a substrate, followed by high temperature sintering in order to anneal the particles and to create a conductive line on the substrate. However, current chipless printable RFID tags have signaling and coding limitations that curtail its' applicability.

The signaling limitation derives from the mode of operation. Tags are composed of an array of antennae with characteristic dimensions corresponding to a frequency within the bandwidth of operation. Such tags are read by stimulating them with a wide band, polarized, short duration RF pulse (commonly called the chirp). A reflected or reradiated signal can then be detected in the orthogonal polarization. Such signal will be depleted in radiation in the wavelength range characteristic of each of the antenna elements that compose the array leading to a phenomenon commonly referred to as an antenna-loading phenomenon. Additionally, multiple reflected signals from the same source or from neighboring sources causes a collision problem that places a substantial limitation on the application of CRFID technology.

Multi resonator tags are difficult to recode using common non-impact printing techniques so their usefulness is largely limited to applications where no additional information is required beyond that which is associated with the tag at manufacture or that assigned in a remote system to that tag code. The recoding limitation is due to the removal of the processing engine from a CRFID tag. The removal of the microprocessor or microcontroller chip and its associated memory from the tag makes it difficult to encode high numbers of bits within a small tag.

It is desired to address the above or at least provide a useful alternative to increase the applicabilities of chipless RFID tags.

### BRIEF SUMMARY OF THE INVENTION

Accordingly, an improved system and method is provided for using the superposition of a number of extremely low cost multiresonator tags that can be configured to be queried with one transmitted query chirp while the multiple chips are all in one physical space. Multiresonator tags could be used to ensure that all the correct items are in the shipping box after the shipping box is sealed.

### BRIEF DESCRIPTION OF THE DRAWINGS

FIG. 1 shows a plan view of a tag composed of an array of resonators/antennae with characteristic dimensions corresponding to a frequency within a bandwidth of operation in accordance to an embodiment;

FIG. 2 shows a block diagram of an RFID reader and tag having one resonator in accordance to an embodiment;

FIG. 3 shows chipless RFID tags in an order fulfillment application in accordance to an embodiment;

FIG. 4A shows a returned signal from a CRFID tag with three resonators where each resonator tuned to a different frequency in accordance to an embodiment;

FIG. 4B shows a retuned signal from a CRFID tag with 0, 1, 2 and 3 resonators tuned to the same frequency in accordance to an embodiment;

FIG. 5 shows a returned signal when two tags are juxtaposed in accordance to an embodiment;

FIG. 6 shows a block diagram of an RFID reader in accordance to an embodiment;

FIG. 7 shows coding scheme where the spectral band is divided into sections in accordance to an embodiment; and

FIG. 8 is a flow diagram illustrating basic steps performed by another method in accordance to an embodiment.

### DETAILED DESCRIPTION OF THE INVENTION

The present invention is directed to a RFID tag, a method, a computer program and to an interrogator or reader.

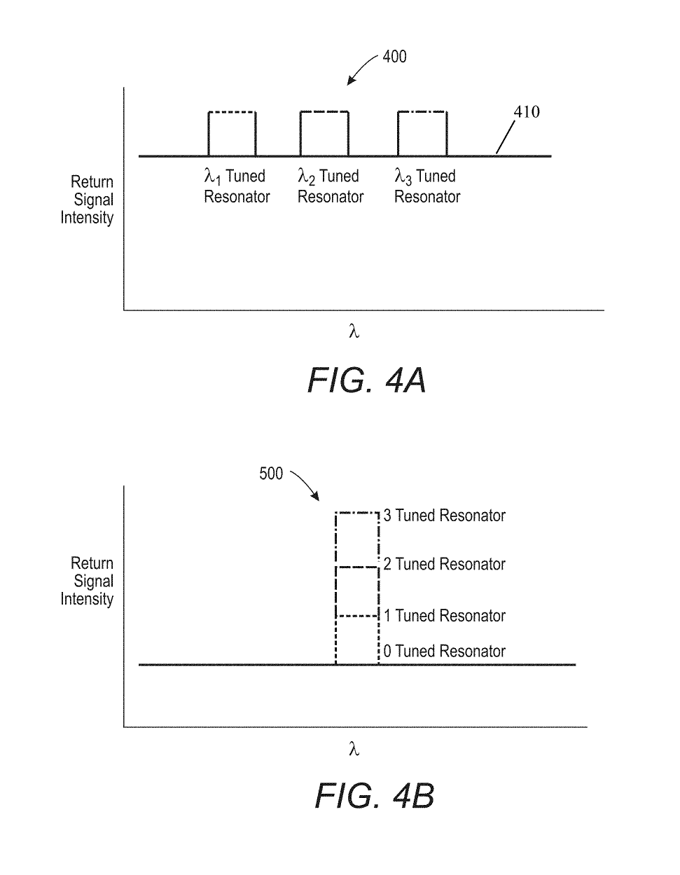

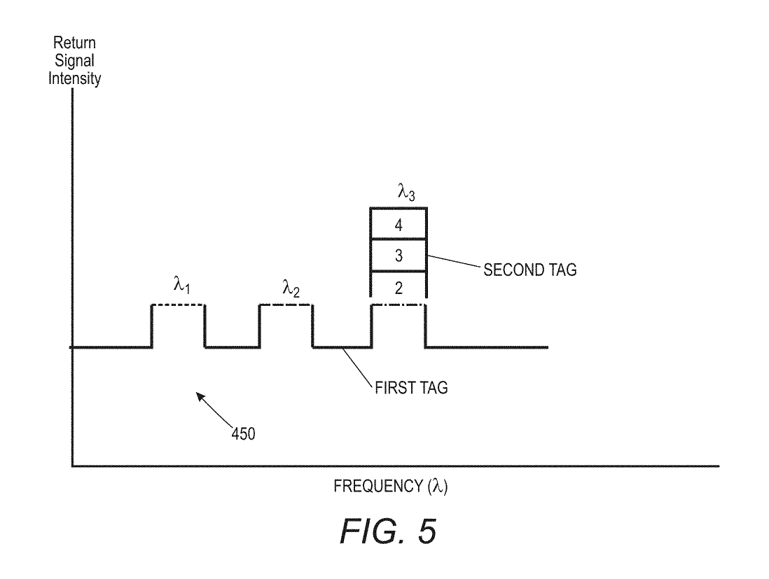

In accordance with an embodiment of the invention, there is provided a RFID tag comprising at least one resonator or antenna for storing data. Information can be stored or recorded in two ways in such a tag, the presence or absence of a resonant structure can be coded as binary “1” or “0” or alternatively multiple resonant structures can be tuned to the same resonant frequency with the resultant attenuation of that region of a signal (chirp) reflective of the number of such structures like shown in FIGS. 4 and 5.

Illustrative examples of the devices, systems, and methods disclosed herein are provided below. An embodiment of the devices, systems, and methods may include any one or more, and any combination of, the examples described below.

Example 1 includes a method comprising wirelessly interrogating chipless radio frequency identification (CRFID) tags each comprising an array of resonators with an electromagnetic radio frequency signal and wherein the CRFID tags are substantially coincident to each other; wherein each CRFID tag encodes information on a collection of objects and an object comprising a CRFID tag and or a combination thereof; receiving a response signal comprising a combination of reflected signals from the array of resonators in the CRFID tags; and processing the response signal to extract the encoded information in the CRFID tags.

Example 2 includes Example 1 and wherein the response signal from the array of resonators is an additive superposition of all signals from the CRFID tags.

Example 3 includes Example 2 and wherein CRFID tags are arranged into one or more groups and where each group comprises one or more CRFID tag.

Example 4 includes Example 3 and wherein one group responds to radiation in a first spectral band that is different from radiation in a second spectral band to which another group responds.

Example 5 includes Example 4 and wherein the electromagnetic radio frequency signal is a wide band and polarized and short duration RF pulse.

Example 6 includes Example 4 and wherein processing the response signal comprises analyzing to identify respective frequencies.

Example 7 includes Example 6 and wherein analyzing includes respectfully identifying frequencies in each of the CRFID tags.

Example 8 includes Example 5 and wherein some of the CRFID tags are layered to encode information on an object to which the tags are affixed.

Example 9 includes Example 5 and wherein some of the CRFID tags are distally positioned relative to each other.

Example 10 a reader system to interrogate with one transmitted query chirp multiple tags located in one physical space comprising a processor; a storage device coupled to the processor; wherein the storage device contains instructions operative on the processor to extract information from chipless radio frequency identification (CRFID) tags each comprising an array of resonators by: wirelessly interrogating the CRFID tags that are substantially coincident to each other using an electromagnetic radio frequency signal; wherein each CRFID tag encodes information on a collection of objects and an object comprising a CRFID tag and or a combination thereof; receiving a response signal comprising a combination of reflected signals from the CRFID tags; and processing the response signal to extract the encoded information in the CRFID tags.

Example 11 includes a non-transitory computer-readable medium storing computer-readable instructions which and when executed by a processor and cause the processor to execute information extraction from chipless radio frequency identification (CRFID) tags located in one physical space and comprising: wirelessly interrogating chipless radio frequency identification (CRFID) tags that are substantially coincident to each other using an electromagnetic radio frequency signal and wherein each of the CRFID tags comprise an array of resonators; wherein each CRFID tag encodes information on a collection of objects and an object comprising a CRFID tag and or a combination thereof; receiving a response signal comprising a combination of reflected signals from the CRFID tags; and processing the response signal to extract the encoded information in the CRFID tags.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of resistors” may include two or more resistors.

The terms “print substrate” or “substrate” generally refers to a usually flexible, sometimes curled, physical sheet of paper, Mylar material, plastic, or other suitable physical substrate for images, whether precut or web fed.

As used herein, the term “tag” refers to a transponder or a combination of a transponder and carrier on which the transponder is disposed. A tag may be attached to articles or objects.

As used herein, the term “transponder” refers to a device that receives signals, such as those transmitted by a reader/interrogator, and sends signals in response to the received signals.

As used herein, the term “resonator” or “resonant structure” means a structure having an associated resonance corresponding to a characteristic frequency. An example of a “resonant structure” is an antenna.

The term “chipless RFID” is used herein to describe an RFID transponder that has neither an integrated circuit nor discrete electronic components, such as a transistor or coil. Further, as used herein, the term “chipless RFID” refers to tags that are composed of an array of antennae with characteristic dimensions corresponding to a frequency within a bandwidth of operation. A “chipless RFID” tag may be a conductive-ink based chipless RFID transponder, wherein all the components, including at least one resonant structure, are formed via patterning of films of conductive material including by laser etching, gravure printing, or printing, such as inkjet printing, a conductive ink.

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein.

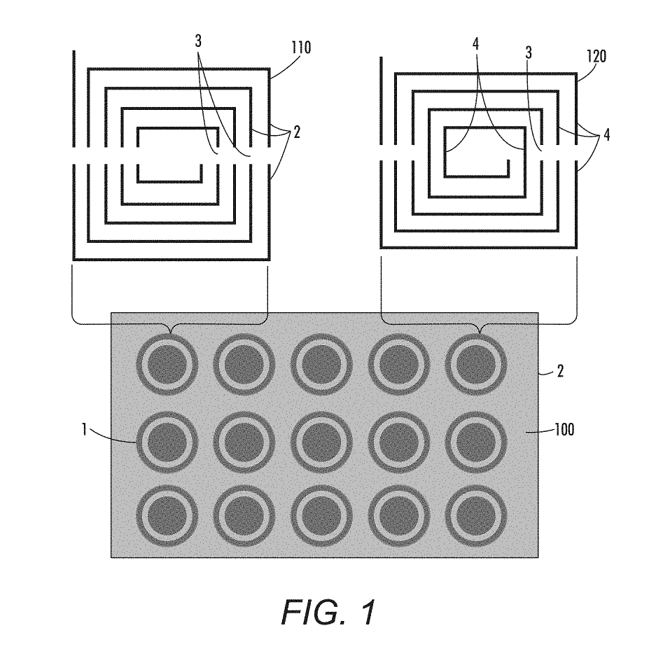

FIG. 1 shows a plan view of a tag 100 composed of an array of antennae with characteristic dimensions corresponding to a frequency within a bandwidth of operation in accordance to an embodiment. Tag 100 can be customized by the use of low resolution printing techniques with conductive inks and its application can be expanded provided there is a way to process the individual tags with a single chirp signal.

Tag 100 is a Chipless RFID tag that includes a dielectric substrate 2 on which an array of antennae 1 are printed or deposited. The substrate 2 can be a non-conductive material, such as paper and the like, and the antennas 2 can be printed using conductive material, e.g. conductive inks. Each antenna elements 1 include a planar structure comprising conductive portions where some are parallel to each other and some in conductive communication with each other. The parallel portions are spaced by a slot which is a non-conductive gap forming an air gap. Each antenna element 1 is surrounded by non-conductive portions of the tag. The antennae 1 are printed on the dielectric substrate 2 at approximately regular intervals with spacing between the antennae selected to substantially avoid electromagnetic interference between pairs of the antenna elements 1 which would interfere with signals in response to a received signal known as a chirp. Each antenna has a characteristic frequency determined by the dimensions and arrangements of the portions. The tag 100 may include antenna elements 1 with a plurality of different characteristic frequencies, e.g. at least one first antenna with a first characteristic frequency F1, at least one second antenna with a second characteristic frequency F2, at least one third antenna with a third characteristic frequency F3, at least one fourth antenna with a fourth characteristic frequency F4, and so forth.

The antenna elements 1 have characteristic dimensions, i.e., line width and feature size, corresponding to a frequency within the bandwidth of operation. The separate wire segments 2 are separated by respective gaps 3 that, if two or more are interconnected, would extend the antenna length. In this manner, the bulk or majority of the antenna pattern can be printed via a printing method as a mass-produced antenna master 110 that can be altered as needed. Unique features can then be added to the antenna master 110 via, for example, digital printing in order to eventually creates a finished chipless RFID tag with unique resonance frequency. As shown the second wire segment 120 the three antenna segment gaps 3 are filled with connecting segments 4 to interconnect four of the ten wire segments 2 to thereby provide a relatively short antenna length. This provides unique antenna geometry on the RFID tag precursor and tag 100. The antennae length is inversely proportional to resonance frequency. Thus, the small antenna length corresponds to high resonance frequency. The antenna loop will be completed to produce a finished RFID tag. Therefore, the finished RFID tags will each have unique response determined by the antenna geometry formed by interconnection of specific wire segments of the antenna master.

Information can be recorded in two ways in tag 100, the presence or absence of a resonant structure can be coded as binary “1” or “0” or alternatively multiple resonant structures can be tuned to the same resonant frequency with the resultant attenuation of that region of the interrogation signal reflective of the number of such structures. Any deviations in the characteristic dimensions results in a detuning of the actual resonance from the intended resonance and hence diminishes the information carrying capacity of a given wavelength band.

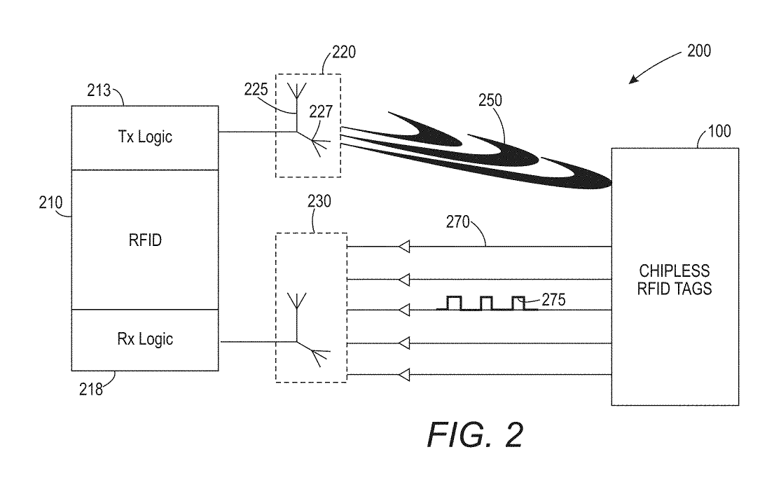

FIG. 2 shows a block diagram of an RFID reader and tag having one resonator in accordance to an embodiment. FIG. 2 shows a block diagram of a RFID system 200, in accordance with the present invention. The RFID system 200 comprises an interrogator like RFID reader 210 and a RFID tag such as chipless RFID tag 100. The RFID reader 210 includes a digital control module with a digital control board shown as Tx Logic 213 that generates voltage controlled oscillator (VCO) signals to drive a radio frequency (RF) transmitter 220 of an RF module. The RF transmitter 220 generates through transmit antennae 225, 227 an interrogation signal 250 taking the form of a wide band, polarized, short duration RF pulse (commonly called the chirp). A reflected or reradiated signal 270 can then be detected in the orthogonal polarization at receiver antenna 230. Such signal will be depleted in radiation in the wavelength range characteristic of each of the antenna elements 1 that compose the array. This is a manifestation of the phenomenon commonly referred to as an antenna-loading phenomenon.

The chipless RFID tag is excited (interrogation signal 250) by a dual polarised transmitter antenna (TX) 220 of the RFID reader 210. The dual polarised transmitter antenna (TX) 220 produces a vertically and horizontally polarised radio frequency (RF) signals at antennae 226 and 227. The advantage of a dual polarized signal is that returned signal is the same regardless of the orientation of the patch since is received by a dual polarized receiver using dual antennae. The antenna element 1 responds to the interrogation signal 250 by producing frequency encoded backscattered signals 270 that are received by a dual polarised receiver antenna (RX) 230.

Absent suitable high resolution, time domain discrimination all tags like tag 100 in the area irradiated by the chirp will contribute attenuated spectra to the receiving device like reader 210. Information can be recorded in two ways in such a tag, the presence or absence of a resonant structure can be coded as binary “1” or “0” or alternatively multiple resonant structures can be tuned to the same resonant frequency with the resultant attenuation of that region of the chirp reflective of the number of such structures (FIGS. 4A and 4B). These methods can be used independently or combined. Accordingly, accurate reading is predicated on the requirement that only one tag is irradiated at a time. This feature, generally referred to as the collision problem, places a substantial limitation on the application of chipless RFID technology.

The backscattered signals or reradiated signal 270 from the tags are received by the receiver antenna 230 and passed to an RF receiver of the RF module shown as RX Logic 216. The RF receiver module 216 processes the received backscattered signals by performing low noise amplification and mixing so as to down convert to a lower intermediate frequency band. The processed intermediate frequency signal is output to a digital signal processor (DSP) of the digital module (not shown). The DSP samples the received signal and executes signal processing algorithms under the control of embedded computer program (middleware) code of a field programmable gate array (FPGA) of the digital module or the like. The code executes signal processing to remove noise and identify or extract the data encoded in the read tag, which represents the tag's identification.

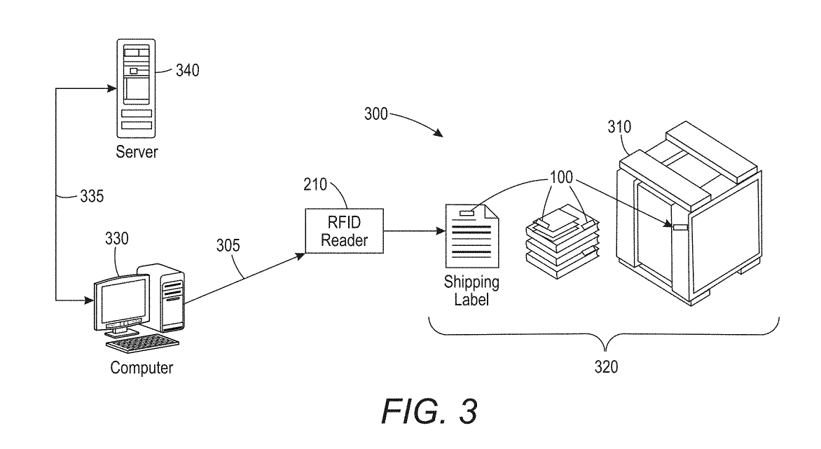

FIG. 3 shows chipless RFID tags in an order fulfillment application in accordance to an embodiment. The digital module of the RFID reader 210 communicates with and is controlled by a back-end computer system 330 which executes a reader control application to generate control commands for the module and receive, store and process tag identification data associated with the items or assets on which the tags are placed such as container 310. The chipless RFID (CRFID) tag 100 can be placed or attached to a container 310, on a collection of items or articles, on documents like shipping labels, or a combination of articles 320. The CRFID tags can be placed distally apart from each other, i.e., a tag can be situated away from the point of attachment or origin or a central point as referenced by a first tag. Tags 100 are centered about or coincident with the location of the RFID reader 210 and each other to respond to the chirp signal. The computer system 330 is a computer system, such as produced by IBM Corporation or Apple computers., having microprocessor circuitry, computer readable medium or memory, and a data communications connection 305 with the reader 210. The computer system 330 may also connected to a server through a network connection 340 that can control the computer 330 or the reader 210 and is capable of receiving data concerning articles with associated tags like Tag 100.

FIG. 4A shows a returned signal from a CRFID tag with three resonators where each resonator tuned to a different frequency in accordance to an embodiment. Response 400 is from a first tag 100 having at least three (3) resonators tuned to different frequencies. Response 400 is shown with a signal that is above an arbitrary threshold value 410 which can set at any value. Tag 100 receives an interrogation message and the resonators like antenna 1 at FIG. 1 provide a response 400 like shown. As can be seen from the response signal intensity the resonators are tuned to different frequencies (λ₁, λ2, λ₃) and as such the tag produces individual signals or a combination of all the signal that are associated with a tag.

FIG. 4B shows a retuned signal from a CRFID tag with 0, 1, 2 and 3 resonators tuned to the same frequency in accordance to an embodiment. Response 500 is from a second tag 100 having at least three (3) resonators tuned to the same frequencies.

FIG. 5 shows a returned signal when two tags are juxtaposed in accordance to an embodiment. As can be seen from FIG. 5 the emission/reflected signals is the additive superposition of the output signals from the resonators. Response 450 is an illustration for two tags that are juxtaposed and simultaneously irradiated, as shown the signal 450 returned is the additive superposition of the individual tags much as a single tag returns the additive superposition of the individual resonators like shown in FIGS. 4A and 4B. Since tags can be customized by the use of low resolution printing techniques with conductive inks and using processing like additive superposition the applicability of tags (first tag, second tag) can be expanded beyond its current capabilities. For example, using low resolution printing and additive superposition an RFID system could be used to ensure that all the correct items for a particular order from a supplier are in the shipping box after the shipping box is sealed. Additionally, useful information can be read from multiple tags at once to acquire type of items in a location especially when the items are arranged into one or more groups, type count for items, item type verification, and the like.

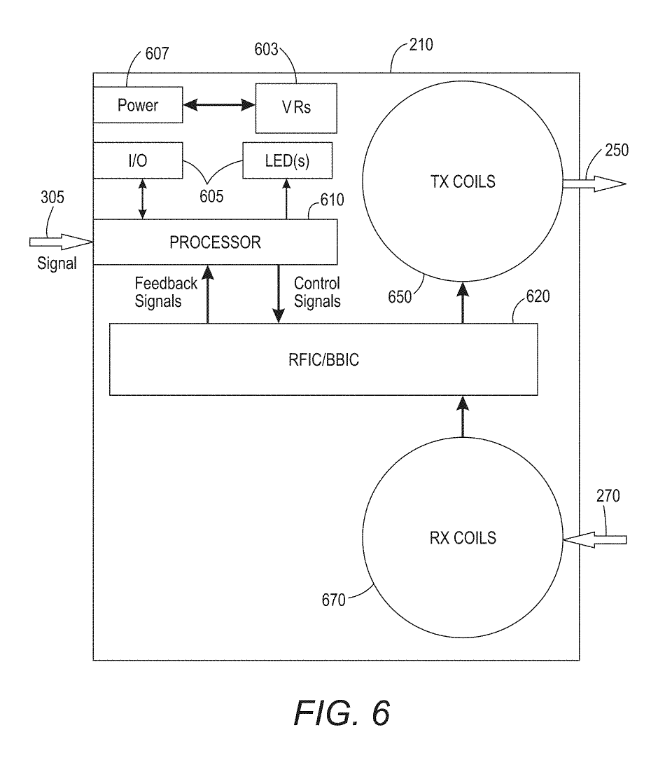

FIG. 6 shows a block diagram of an RFID reader 210 in accordance to an embodiment. Note that portions which are the same as those in the embodiment described above are denoted by the same reference numerals, and descriptions of the same portions as those as in the above embodiments will be omitted. Next, a second embodiment of the present invention will be described. The RFID reader 210 comprises a processor 610, a signal processing unit 620 such as a radio frequency or baseband integrated circuit, input port and indicators like USB and LEDs 605, and transmission antenna 650 and receiving antenna 670. A power source 607 and voltage regulator 603 are shown for managing the voltage requirements of the reader. The processor 610 executes a computer program product which is permanently stored on a storage device (not shown) and loaded into the processor 610, for example, after the startup of the RFID reader 210.

In order to read out the tags such as chipless RFID tag (CRFID) 100, the processor 610 of the reader 210 generates an interrogation signal (chirp) 250 which is an electromagnetic signal in the radio frequency range, which is adapted for reading out tags like CRFID 100, and which is emitted by the antenna 650 so that the interrogation signal 250 irradiates the CRFID tag 100. The resonators of the CRFID tag 100 receive the interrogation signal 250. The interrogation signal 250 travels down the strip lines of each resonator in each of the tags, like wire segments 2 of resonator 120 in FIG. 1, and is scattered back as a modulated interrogation signal 250 representing response signals from tags in the line of sight of antenna 650.

The back reflected or back scattered interrogation signal 270 from each resonator travels back through the strip lines to the antenna 670. These signals (i.e., the response signal from the resonators) arrive at receiver antenna 670 and processed by the signal processing unit, RFIC 620 and Processor 610, after the back scattered signal has been detected by antenna 670. Since there are multiple reflected signals the response signal that is generated is the superposition of the back scattered signals which are generated by the strip lines from the respective resonators. Information is transported in the reflected signal where the presence or absence of a resonant structure can be coded as binary or alternatively multiple resonant structures can be tuned to the same resonant frequency with the resultant attenuation of that region of the chirp reflective of the number of such structures.

The reflected signal comprises an encoded data which correspond to the combination of the interrogation signal 250 and the response signal from each resonator. The signal processing unit extracts the encoded data from the back scattered interrogation signal or response signal 270. The computer program product using processor 610 decodes the encoded data to generate a response signal like shown in FIGS. 4A, 4B, and 5.

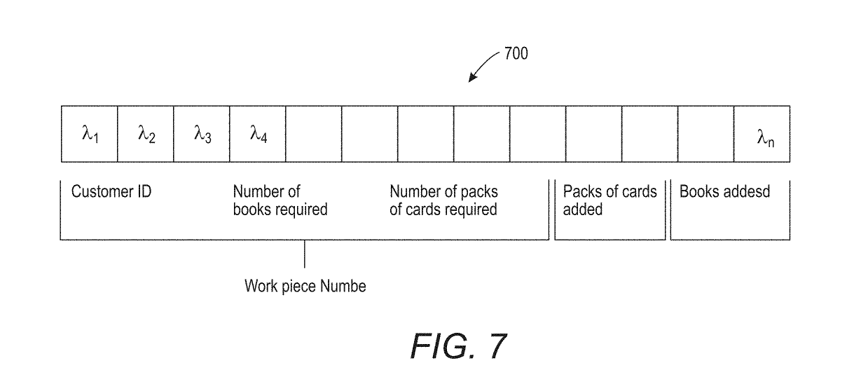

FIG. 7 shows coding scheme where the spectral band is divided into sections in accordance to an embodiment. The example shown in FIG.7 is an illustration of the principle of exploiting the superposition of tags to allow layering of tags to encode information on an object to which the tags are affixed. The illustration should not be taken as limiting as many other applications will be evident to one skilled in the art.

A production system may have a work piece that must complete several steps to be completed. Each such piece may have a known number of specific steps to be completed but those steps may be different both in number and in unit process from one piece to another. Moreover the completion of some of those steps may be difficult or impossible to verify without disassembly of the work piece. As an example in printing, an order for customized books and cards may require a number of books and a number of packages of cards that must be assembled and packaged assessed, the package sealed and the shipping label printed and applied. A given order may be assigned a number unique from all others under production at that time which is coded to correspond to a record in a central information technology (IT) database the system with the customer's shipping data and the number of books and packs of cards to be included. This tag is applied to a shipping container appropriate to contain the entire order. The order may consist of a “N” components of “X” types. The total number of items, “T”, in the order is then a summation (ΣNXᵢ) for the number of items of each type.

FIG. 7 shows a coding scheme where the spectral band (λ) is divided into sections 700 to indicate different aspects of an order or item being assembled. As shown the CRFID tags are arranged into one or more groups and each group comprises one or more CRFID tag. Some numbers of the sections are devoted to coding individual order identification (ID) like customer identifier and number of items forming an order. This ID might be connected to a production and enterprise resource planning (ERP) system and link to the original full order details (types of objects, the number of each, shipping and billing information, and the like). Other groups sections are devoted to each of the item types (λ₁=book, λ₂=card, λ₃=postcard, and so forth). When the full order is produced and assembled the full area of the container like box 310 in which the items to be shipped is irradiated with a chirp and the resultant composite returned signal is analyzed. The order number will be returned at an amplitude dictated by the total number of items (FIG. 4B) in the shipment and the individual component types will give a return dictated by the number of items of the particular type (FIG. 5). Accordingly it is possible to ascertain that the entire order is indeed produced and assembled in the container for shipment.

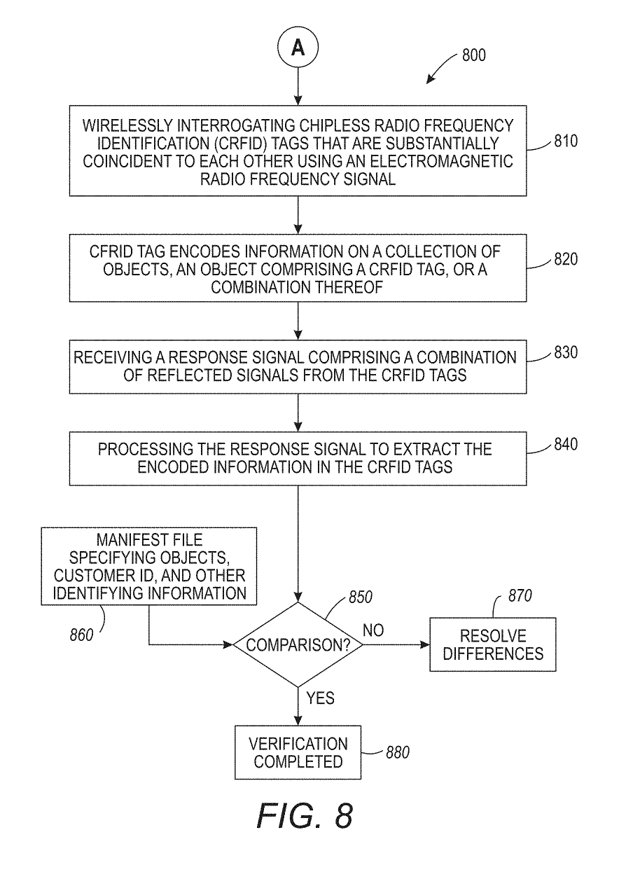

FIG. 8 is a flow diagram illustrating basic steps performed by another method in accordance to an embodiment. Method 800 illustrates the benefits of a system to ensure that all the correct items for a particular order are in the shipping box even after the shipping box is sealed. Action 810 causes a system to wirelessly interrogate chipless radio frequency identification (CRFID) tags that are substantially coincident to each other using an electromagnetic radio frequency signal.

Action 820 can be performed before action 810 or after action 810 where a CRFID tag is caused to encode information on a collection of objects, an object comprising a CRFID tag, or a combination thereof. Like described in FIG. 7 tags can be created on media like paper or on surfaces of different material like the wood/plastic of a shipping container. Action 830 causes a system to receive a response signal to the interrogation signal of action 810 that comprises a combination of reflected signals from the CRFID tags. Action 830 causes the system to processes the response signal to extract the encoded information in the CRFID tags.

In action 850, information from the CRFID tags all occupying a particular space like a container and information from a manifest file 860 that comprises information as to the order such as customer ID and number of items by type. If the comparison fails, i.e. the order does not match the items in the shipping box, then a resolution is made like adding items and actions 810-850 are repeated until the order matches the manifest file 860. When the comparison indicates a match the verification is completed 880 and the shipping box is forwarded to the customer. It is noted that shipping label could be produced from the information from the CRFID tags in the container.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method, comprising:
wirelessly interrogating chipless radio frequency identification (CRFID) tags each comprising an array of resonators with an electromagnetic radio frequency (RF) signal, wherein the CRFID tags are substantially coincident to each other;
wherein the signal is a single short duration RF pulse that simultaneously irradiates the CRFID tags;
wherein each CRFID tag encodes information on a collection of objects, an object comprising a CRFID tag, or a combination thereof;
wherein each CRFID tag is printed on a substrate using a conductive metal ink;
receiving a response signal comprising a combination of reflected signals from the array of resonators in the CRFID tags; and
processing the response signal to extract the encoded information in the CRFID tags.

2. The method according to claim 1, wherein the response signal from the array of resonators is an additive superposition of all signals from the CRFID tags.

3. The method according to claim 2, wherein CRFID tags are arranged into one or more groups and where each group comprises one or more CRFID tag.

4. The method according to claim 3, wherein one group responds to radiation in a first spectral band that is different from radiation in a second spectral band to which another group responds.

5. The method according to claim 4, wherein the electromagnetic radio frequency signal is wide band and polarized.

6. The method according to claim 4, wherein processing the response signal comprises analyzing to identify respective frequencies.

7. The method according to claim 6, wherein analyzing includes respectfully identifying frequencies in each of the CRFID tags.

8. The method according to claim 5, wherein some of the CRFID tags are layered to encode information on an object to which the tags are affixed.

9. The method according to claim 5, wherein some of the CRFID tags are distally positioned relative to each other.

10. A reader system to interrogate with one transmitted query chirp multiple tags located in one physical space comprising:
a processor;
a storage device coupled to the processor;
wherein the storage device contains instructions operative on the processor to extract information from chipless radio frequency identification (CRFID) tags each comprising an array of resonators by:
wirelessly interrogating the CRFID tags that are substantially coincident to each other using an electromagnetic radio frequency (RF) signal;
wherein the signal is a single short duration RF pulse that simultaneously irradiates the CRFID tags;
wherein each CRFID tag encodes information on a collection of objects, an object comprising a CRFID tag, or a combination thereof;
wherein each CRFID tag is printed on a substrate using a conductive metal ink;
receiving a response signal comprising a combination of reflected signals from the CRFID tags; and
processing the response signal to extract the encoded information in the CRFID tags.

11. The reader system according to claim 10, wherein the response signal from the CRFID tags is an additive superposition of all signals from the CRFID tags.

12. The reader system according to claim 11, wherein the CRFID tags are arranged into one or more groups and where each group comprises one or more CRFID tag.

13. The reader system according to claim 12, wherein one group responds to radiation in a first spectral band that is different from radiation in a second spectral band to which another group responds.

14. The reader system according to claim 13, wherein the electromagnetic radio frequency signal is wide band and polarized.

15. The reader system according to claim 14, wherein processing the response signal comprises analyzing to identify respective frequencies.

16. The reader system according to claim 15, wherein analyzing includes respectfully identifying frequencies in each of the CRFID tags.

17. The reader system according to claim 14, wherein some of the CRFID tags are layered to encode information on an object to which the tags are affixed.

18. The reader system according to claim 14, wherein some of the CRFID tags are distally positioned relative to each other.

19. A non-transitory computer-readable medium storing computer-readable instructions which, when executed by a processor, cause the processor to execute information extraction from chipless radio frequency identification (CRFID) tags located in one physical space, comprising:
wirelessly interrogating chipless radio frequency identification (CRFID) tags that are substantially coincident to each other using an electromagnetic radio frequency (RF) signal, wherein each of the CRFID tags comprise an array of resonators;
wherein the signal is a single short duration pulse that simultaneously irradiates the CRFID tags;
wherein each CRFID tag encodes information on a collection of objects, an object comprising a CRFID tag, or a combination thereof;
wherein each CRFID tag is printed on a substrate using a conductive metal ink;
receiving a response signal comprising a combination of reflected signals from the CRFID tags; and
processing the response signal to extract the encoded information in the CRFID tags.

20. The non-transitory computer-readable medium storing computer-readable instructions according to claim 19, wherein the response signal from the CRFID tags is an additive superposition of all signals from the CRFID tags;
wherein the CRFID tags are arranged into one or more groups and where each group comprises one or more CRFID tag;
wherein one group responds to radiation in a first spectral band that is different from radiation in a second spectral band to which another group responds;
wherein the electromagnetic radio frequency signal is a wide band, polarized, short duration RF pulse.
